(19) United States
(12) Patent Application Publication
(10) Pub. No.: US 2026/0148638 A1
(43) Pub. Date: May 28, 2026

(54) BLIND-SPOT DETECTION AND ACCIDENT PREVENTION FOR VEHICLES

(71) Applicant: Volvo Car Corporation, Göteborg (SE)

(72) Inventor: Oswaldo Perez Barrera, Gothenburg (SE)

(21) Appl. No.: 18/956,969

(22) Filed: Nov. 22, 2024

(51) Int. Cl. G08G 1/16

(52) U.S. Cl. CPC G08G 1/166

(57) ABSTRACT

Techniques for object identification and accident prevention for vehicles in hazardous (e.g., low visibility) conditions are provided. In an example, a method comprises detecting, by a system onboard a vehicle comprising a processor, presence of vehicles and determining respective location, size, trajectory or speed of the detected vehicles. The method can further comprise detecting, by the system, presence of objects or pedestrians and determining respective location, size, trajectory or speed of the detected objects or pedestrians. The method can further comprise analyzing, by the system, the determined respective location, size, trajectory or speed of the detected vehicles, objects or pedestrians and predicting risk of collision. The method can further comprise issuing, by the system, a warning to the respective detected vehicles or pedestrians as a function of the predicted risk of collision.

### TECHNICAL FIELD

The disclosed subject matter relates to vehicles (e.g., transportation vehicles), and more particularly, to blind-spot detection and accident prevention systems for vehicles.

### BACKGROUND

Blind spot collisions are a major hazard on roads worldwide, presenting critical challenges to driver and passenger safety. Blind spots can obscure other vehicles, pedestrians, or obstacles from a driver's view, creating situations where sudden and unexpected hazards become visible too late to safely react. These risks are particularly pronounced in scenarios where visibility is compromised by other vehicles or environmental factors, as drivers often cannot anticipate hidden hazards until they are immediately in their path. Such accidents are common during routine maneuvers like lane changes, left turns, or merging, where a vehicle's structure or the position of other objects on the road can effectively shield unseen obstacles.

Despite advancements in sensor and alert technologies, many existing systems inadequately address blind-spot dangers, as they are often limited to detecting hazards within a narrow range or under specific conditions. Current solutions, including camera and radar-based systems, tend to rely on line-of-sight detection, which restricts their ability to preemptively warn drivers about hidden obstacles that are only temporarily obstructed. The limitations of these systems create a need for a more comprehensive and proactive approach—one that leverages predictive awareness and real-time hazard assessment to anticipate and alert drivers of potential collisions before they materialize in the driver's field of view. Such a solution could significantly enhance road safety by mitigating the risks associated with blind spots more effectively than conventional systems, ultimately reducing the frequency and severity of avoidable collisions.

The above-described background relating to object identification and accident prevention systems for vehicles is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products can facilitate early detection of blind spots and enable proactive adjustment to vehicle dynamics.

Blind spot collisions represent a persistent and serious threat to road safety, often resulting in high-impact accidents. These incidents typically arise when a vehicle, pedestrian, or object is obscured from a driver's view by other vehicles, road features, or blind spots within the vehicle's structure itself. This visual obstruction can lead to delayed reactions, as drivers are often unaware of hidden hazards until they are suddenly exposed, leaving little time to make necessary maneuvers to avoid a collision. Commonly occurring during left turns, lane changes, and intersection navigation, these accidents can be difficult to predict due to the dynamic and rapidly changing nature of the driving environment.

Although many modern vehicles come equipped with sensor-based technologies, such as cameras, ultrasonic sensors, or radar systems, these solutions frequently fall short in providing comprehensive blind spot coverage. Such systems tend to rely on line-of-sight detection, which limits their capacity to detect hazards that are briefly obscured by other vehicles or structural components in the vehicle's design. Additionally, most existing technologies alert the driver only when a threat is within a certain close proximity, which may be too late to take appropriate action. The limitations of these approaches underscore the need for a solution that can analyze a more extensive range of potential hazards in real time, accounting for vehicles, pedestrians, and other obstacles that may not yet be visible to the driver.

To effectively reduce the risks associated with blind spot collisions, there is a clear need for an advanced solution that moves beyond conventional line-of-sight limitations. Such a system could provide more meaningful warnings and give drivers a critical time advantage in avoiding blind spot-related accidents. This approach has the potential to transform blind spot detection from a reactive to a proactive safeguard, offering a significantly improved level of protection on the road.

The proposed solution leverages a system where an autonomous vehicle (“AV”) can continuously monitor and track visibility conditions of road sections. The AV can detect objects using radar, including other vehicles, and determine blind spots of other vehicles. The AV can determine a risk of collision based upon the determined blind spots, such as if a first vehicle (“V1”) is obstructing the view of a second vehicle (“V2”) such that V2 cannot foresee that is likely to collide with a third vehicle (“V3”). In the event that a collision between V2 and V3 is likely, the AV can transmit a warning to nearby vehicles (any combination of V1, V2, or V3, for example) to help mitigate the risk of collision. In situations where there is a pedestrian present (for example, V1 obstructs V2's view of the pedestrian such that V2 is likely to collide with the pedestrian), the AV can also transmit a warning to the pedestrian. The AV can analyze relevant factors which may contribute to vehicle blind spots, such as vehicle sizes and speeds, visibility conditions, road shapes (such as if the road curves, thereby obstructing a view of oncoming traffic or pedestrians), or any other relevant factors that can contribute to the creation of blind spots or impact a vehicle's ability to avoid a collision. In certain scenarios, the AV can perform head pose estimation algorithms on drivers of other vehicles to determine a level of awareness of the drivers, which the AV can further factor into its analysis of likelihood of collision.

As alluded to above, improved techniques for visibility level estimation and proactive vehicle safety control are desirable, and various embodiments are described herein to this end and/or other ends.

According to an embodiment, a system can comprise a memory that stores computer executable components, and a processor that executes the computer executable components stored in the memory, including a vehicle detection component detects presence of vehicles and determines respective location, size, trajectory or speed of the detected vehicles. The computer executable components can further include an environmental detection component that detects respective objects or pedestrians and determines location, size, trajectory or speed of the respective detected objects or pedestrians. The computer executable components can further include an accident risk analysis component that analyzes the determined respective location, size, trajectory or speed of the respective detected vehicles, objects or pedestrians and predicts risk of collision. The computer executable components can further include a communication component that issues a warning to the respective detected vehicles or pedestrians as a function of the predicted risk of collision.

According to another embodiment, a method can comprise detecting, by a system onboard a vehicle comprising a processor, presence of vehicles and determining, by the system, respective location, size, trajectory or speed of the detected vehicles. The method can further comprise detecting, by the system, respective objects or pedestrians and determining, by the system, location, size, trajectory or speed of the respective detected objects or pedestrians. The method can further comprise analyzing, by the system, the determined respective location, size, trajectory or speed of the respective detected vehicles, objects or pedestrians and predicting, by the system, risk of collision. The method can further comprise issuing, by the system, a warning to the respective detected vehicles or pedestrians as a function of the predicted risk of collision.

According to yet another embodiment, a non-transitory machine-readable medium can comprise executable instructions that, when executed by a processor integrated on or within a vehicle, facilitate performance of operations, comprising, detecting presence of vehicles, determining respective location, size, trajectory or speed of the detected vehicles, detecting respective objects or pedestrians, and determining location, size, trajectory or speed of the respective detected objects or pedestrians. The instructions can further cause the processor to analyze the determined respective location, size, trajectory or speed of the respective detected vehicles, objects or pedestrians and to predict a risk of collision. The instructions can further cause the processor to issue a warning to the respective detected vehicles or pedestrians as a function of the predicted risk of collision.

### BRIEF DESCRIPTION OF DRAWINGS

FIGS. 1-2 illustrate block diagrams of example accident prevention systems, in accordance with one or more embodiments described herein.

FIG. 3 illustrates example road scenarios for blind spot detection and collision prevention in accordance with one or more embodiments described herein.

FIGS. 4A-4J illustrate diagrams of example, non-limiting computer implemented methods that can facilitate blind spot detection and collision prevention, and which include example road scenarios for blind spot detection and collision prevention, in accordance with one or more embodiments described herein.

FIGS. 5A-5F illustrate example road scenarios for blind spot detection and collision prevention in accordance with one or more embodiments described herein.

FIGS. 6A and 6B illustrates a flow diagram of an example, non-limiting computer implemented method that can facilitate blind spot detection and collision prevention in accordance with one or more embodiments described herein.

FIG. 7 is an example of a non-limiting computing environment in which one or more embodiments described herein can be implemented.

FIG. 8 is an example of a non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As alluded to above, improved techniques for object visibility estimation and proactive vehicle safety control are desirable, and various embodiments are described herein to this end and/or other ends. In accordance with one or more embodiments, the disclosed solution provides a safety system for vehicles that facilitates early detection of vehicle blind spots and proactive collision prevention. In various embodiments, the onboard computer system of the vehicle can comprise a memory that stores computer-executable components, and a processor that executes the computer executable components stored in the memory. These computer-executable components can include a vehicle detection component that detects presence of vehicles and determines respective location, size, trajectory or speed of the detected vehicles. The computer-executable components can further comprise an environmental detection component that detects respective objects or pedestrians and determines location, size, trajectory or speed of the respective detected objects or pedestrians. The computer-executable components can further comprise an accident risk analysis component that analyzes the determined respective location, size, trajectory or speed of the respective detected vehicles, objects or pedestrians and predicts risk of collision. The computer-executable components can further comprise a communication component that issues a warning to the respective detected vehicles or pedestrians as a function of the predicted risk of collision.

In some embodiments, the computer-executable components can further comprise a blind-spot detection component that uses information gathered by the vehicle detection component to identify blind spots of the detected vehicles. In other embodiments, the accident risk analysis component can use the identified blind spots to predict the risk of collision. The accident risk analysis component can predict a high risk of collision based on the identified blind spots.

In some embodiments, the environmental detection component further detects weather conditions. The environmental detection component can further detect road conditions, and/or behaviors of the pedestrians.

According to some embodiments, the vehicle detection component cam detect behaviors of the vehicles. The vehicle detection component can use radar and visual sensors to detect the presence of the vehicles. The vehicle detection component can use radar and/or visual sensors to determine locations, sizes, trajectories or speeds of the detected vehicles.

In various embodiments, the computer-executable components can further comprise a regulation component that regulates driving of the vehicle based on the predicted risk of collision. The regulation component can regulate driving of the detected vehicles based on the predicted risk of collision. In some embodiments, the regulation component reduces speed of the vehicle. The regulation component can activate a light of the vehicle, change a setting of the vehicle, or transmit a warning to a user of the vehicle. In other embodiments, the regulation component can facilitate driving of the vehicle based on the predicted risk of collision. In further embodiments, the vehicle can proactively notify the driver of the predicted risk of collision or can automatically modify driving parameters, such as reducing speed, adjusting braking force, or altering steering inputs, to minimize the risk of collision, thereby enhancing overall safety.

In some embodiments an artificial intelligence component can be used to regulate control of the vehicle based on the determined respective location, size, trajectory or speed of the respective detected vehicles, objects or pedestrians and the predicted risk of collision.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments described herein.

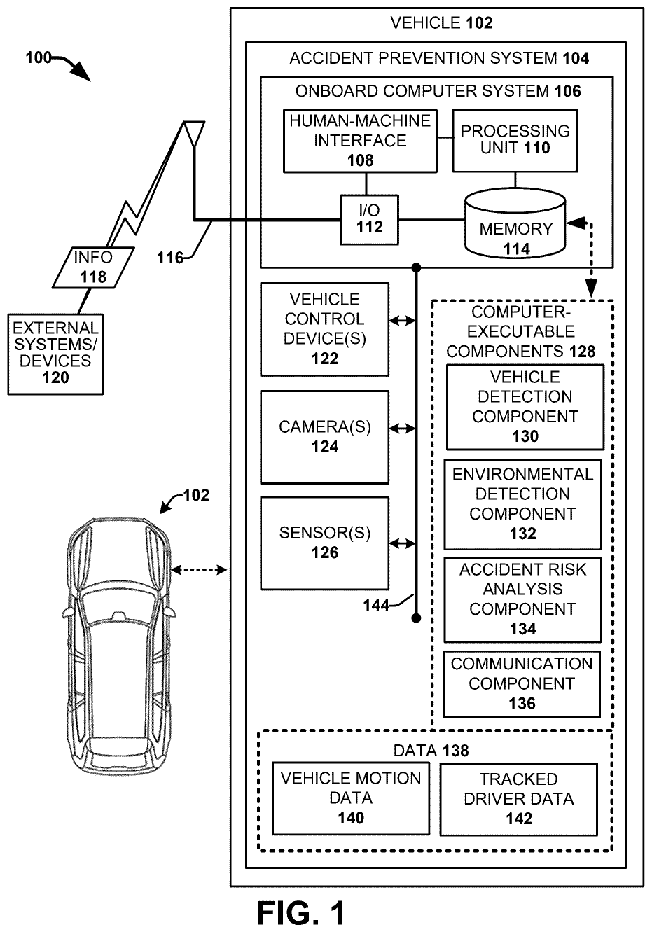

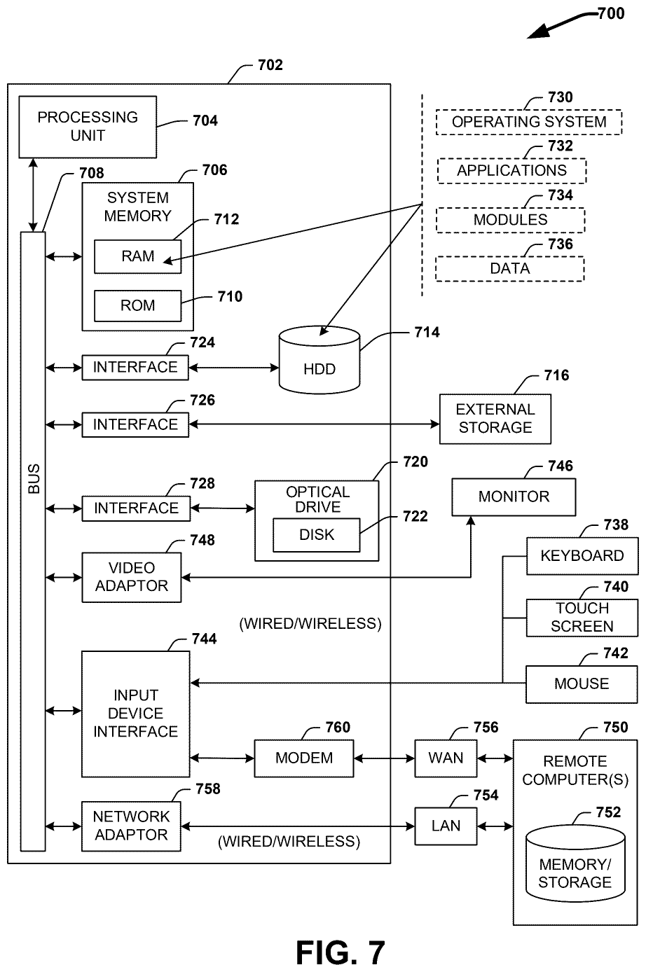

Turning now to the drawings, FIG. 1 illustrates a block diagram of an exemplary system 100 that facilitates early detection of vehicle blind spots and proactive collision prevention. System 100 includes a vehicle 102 comprising an accident prevention system 104 integrated thereon or therein. The accident prevention system 104 includes one or more vehicle control device 122, one or more cameras 124, one or more sensors 126 and an onboard computer system 106. The onboard computer system 106 comprises at least one memory 114 that stores computer-executable components 128 and data 138 that facilitate early detection of vehicle blind spots and enables proactive collision prevention of vehicle 102 and/or of other nearby vehicles. These computer-executable components include (but are not limited to) vehicle detection component 130, environmental detection component 132, accident risk analysis component 134, and communication component 136. The onboard computer system 106 includes at least one processor or processing unit 110 that executes the computer-executable component 128 stored in memory 114 to carry out the operations/functions described with respect to the corresponding computer-executable components. Examples of said memory 114, processing unit 110, and other computer system components that can be included in the onboard computer system 106 to facilitate the various features and functionalities of system 100 can be found with reference to FIG. 7 (e.g., system memory 706, processing unit 704, and the like).

The onboard computer system 106 can further include an input/output (I/O) component 112, wherein the I/O component 112 can be a transceiver configured to enable transmission/receipt of information 118 between the onboard computer system 106 and various external systems or devices 120. For example, the external systems or devices 120 can correspond to any type of device or computing system configured to wirelessly communicate (e.g., using radio frequency signals) with the onboard computer system 106, such as but not limited to, a mobile device associated with one or more users of the vehicle 102 (e.g., a smartphone, a smartwatch, a tablet, eyewear, a wearable headset or another type of wearable device), an external computer, an external computer system, an external application server, another vehicle's onboard computer system, and so on. The I/O component 112 can be communicatively coupled, via an antenna 116, to the remotely located devices and systems (e.g., external systems/devices 120). Any suitable technology can be utilized to enable the various embodiments presented herein, regarding transmission and receiving of information 118 between the onboard computer system 106 and one or more external systems/devices 120. Suitable technologies include BLUETOOTH®, cellular technology (e.g., 3G, 4G, 5G), internet technology, ethernet technology, ultra-wideband (UWB), DECAWAVE®, IEEE 802.15.4a standard-based technology, Wi-Fi technology, Radio Frequency Identification (RFID), Near Field Communication (NFC) radio technology, and the like.

The onboard computer system 106 can also include a human-machine interface 108 that provides for receiving user input in association with utilizing the various features and functionalities of the computer-executable component 134 and presenting information to users. For example, the human-machine interfaces 108 can include or correspond to any suitable output device such as a display, a speaker, etc. and any suitable input device, such as a touchscreen display, a microphone, a keypad, a keyboard, a camera, a gesture input device/system, a voice input device/system, and the like. Examples of suitable input and output devices of the human-machine interface 108 devices are further provided with reference to FIG. 7. The friction estimation system 104 also include a system bus 144 that communicatively and operatively couples the onboard computer system 106, the one or more vehicle control device 122, the one or more cameras 124 and the one or more sensors 126 to one another using any suitable wired or wireless communication technology.

Vehicle 102 can correspond to any suitable type of transportation vehicle comprising one or more windows and adapted for use in scenarios in which monitoring the external environment is important, such as varying weather conditions or navigation in complex environments. For instance, vehicle 102 can include or correspond to any suitable type of motor vehicle (e.g., a car, a truck, a van, a sport utility vehicle (SUV), etc.). In some implementations vehicle 102 can also include or correspond to an aircraft (e.g., an airplane, a helicopter, or the like), a watercraft, or another type of passenger transportation vehicle. In some embodiments, vehicle 102 can include or correspond to an autonomous vehicle that is capable of navigating and operating without (or some) human input.

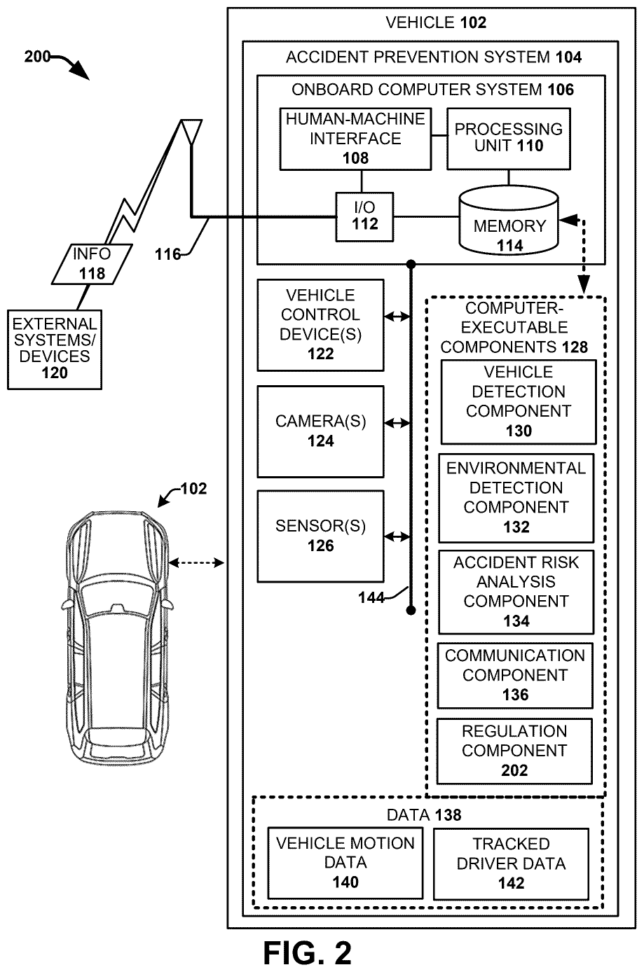

FIG. 2 illustrates an example system 200 that can facilitate early detection of vehicle blind spots and enables proactive collision prevention of vehicle 102 and/or other vehicles. System 200 includes a vehicle 102 comprising an accident prevention system 104 integrated thereon or therein. The accident prevention system 104 includes one or more vehicle control device 122, one or more cameras 124, one or more sensors 126 and an onboard computer system 106. The onboard computer system 106 comprises at least one memory 114 that stores computer-executable components 128 and data 138 that facilitate early detection of vehicle blind spots and enables proactive collision prevention of vehicle 102 and/or other vehicles. System 200 includes computer-executable components including (but are not limited to) vehicle detection component 130, environmental detection component 132, accident risk analysis component 134, and communication component 136, and artificial intelligence component 202. The onboard computer system 106 includes at least one processor or processing unit 110 that executes the computer-executable component 128 stored in memory 114 to carry out the operations/functions described with respect to the corresponding computer-executable components.

The vehicle detection component 130 can detect presence of vehicles and can determine respective location, size, trajectory or speed of the detected vehicles. The vehicle detection component 130 can further detect behaviors of the detected vehicles. The vehicle detection component 130 can use radar and/or visual sensors to detect the presence of the vehicles. The vehicle detection component 130 can use radar and/or visual sensors to determine the locations, sizes, trajectories or speeds of the detected vehicles.

The environmental detection component 132 can detect respective objects or pedestrians and can determine location, size, trajectory or speed of the respective detected objects or pedestrians. The environmental detection component 132 can further detect weather conditions, road conditions, and/or behaviors of the pedestrians.

The accident risk analysis component 134 can analyze the determined respective location, size, trajectory or speed of the respective detected vehicles, objects or pedestrians and can predict risk of collision.

The communication component 136 can issue a warning to the respective detected vehicles or pedestrians as a function of the predicted risk of collision.

The regulation component 202 can facilitate driving of the vehicle 102 and/or of the detected vehicles based on the predicted risk of collision. The regulation component 202 can regulate driving of the vehicle 102. The regulation component 202 can regulate driving of the detected vehicles. The regulation of the vehicle 102 and/or the detected vehicles can be based on the predicted risk of collision.

In some embodiments, the computer-executable components 128 can further comprise a blind-spot detection component that uses information gathered by the vehicle detection component 130 to identify blind spots of the detected vehicles. The accident risk analysis component 134 can use the identified blind spots to predict the risk of collision. The accident risk analysis component 134 can predict a high or low risk of collision based on the identified blind spots. The accident risk analysis component 134 can use the identified blind spots to adjust the predicted risk of collision.

The artificial intelligence component 202 can regulate control of the vehicle based on the determined respective location, size, trajectory or speed of the respective detected vehicles, objects or pedestrians and the predicted risk of collision.

In various embodiments, artificial intelligence component 202 can regulate vehicle control based on real-time analysis of the determined respective location, size, trajectory or speed of the respective detected vehicles, objects or pedestrians and/or predicted risk of collision. The artificial intelligence component 202 can adjust driving parameters of vehicle 102 and/or of the detected vehicle(s), such as speed, braking, and steering, to optimize safety and mitigate the risk of collision under varying road conditions.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

One or more systems, devices, computer program products, and/or computer-implemented methods provided herein relate to blind spot detection and accident prevention for vehicles in various conditions. A system can include a processor that executes computer executable components stored in memory. The computer executable components can include a vehicle detection component that detects presence of vehicles and determines respective location, size, trajectory or speed of the detected vehicles. The computer executable components can further include an environmental detection component that detects respective objects or pedestrians and determines location, size, trajectory or speed of the respective detected objects or pedestrians. The computer executable components can further include an accident risk analysis component that analyzes the determined respective location, size, trajectory or speed of the respective detected vehicles, objects or pedestrians and predicts risk of collision. The computer executable components can further include a communication component that issues a warning to the respective detected vehicles or pedestrians as a function of the predicted risk of collision.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 110 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

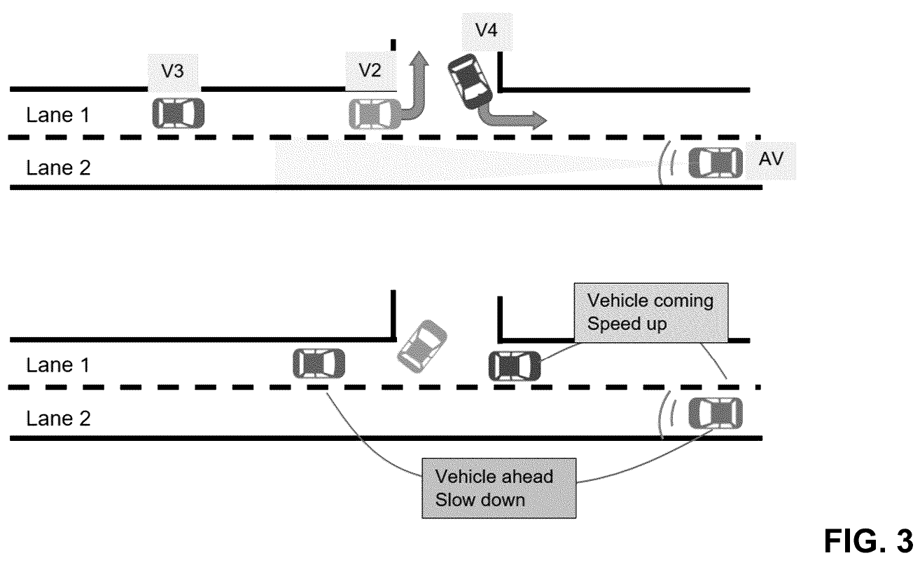

FIG. 3 illustrates example road scenarios for early detection of vehicle blind spots and proactive collision prevention in accordance with one or more embodiments described herein. In an embodiment, the AV can determine locations, behaviors and sizes of nearby vehicles (e.g., V2, V3, and/or V4). The Av can then determine blind spots of the nearby vehicles based upon the determined locations, behaviors and sizes of the respective vehicles. According to an embodiment, the AV can predict the likelihood of a future collision based upon the determined locations, behaviors, sizes, and blind spots of the respective vehicles. The AV can communicate with any one or more of the nearby vehicles. For example, the AV can recognize that V4 is attempting to enter the lane (depicted as Lane 1 in FIG. 3). The AV can further recognize that V2 is blocking V3's view of V4 (e.g., V4 is in V3's blind spot), and that a future collision between V2 and V4 is likely to occur. Upon such a determination, the AV can communicate a warning to any nearby vehicles (in the example diagram of FIG. 3, the nearby vehicles could comprise any combination of V2, V3, and V4), thereby reducing the likelihood of a collision. According to some embodiments, the AV could regulate diving of nearby vehicles to prevent the collision. For example, the AV could determine that a warning would not be sufficient to prevent the collision from occurring. Instead, the AV could regulate control of V3 and V4, such as by causing them both to reduce speed or to brake, in order to reduce the likelihood of collision.

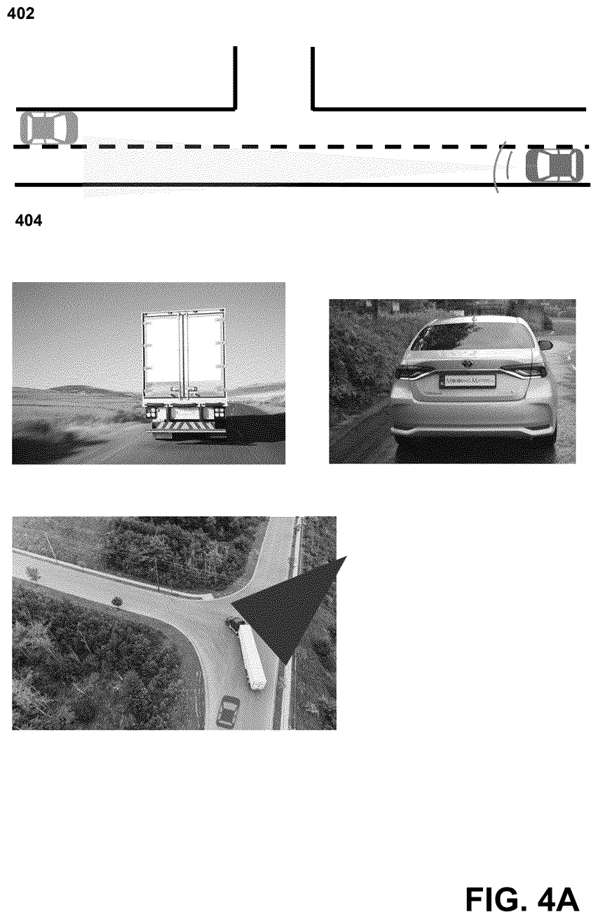

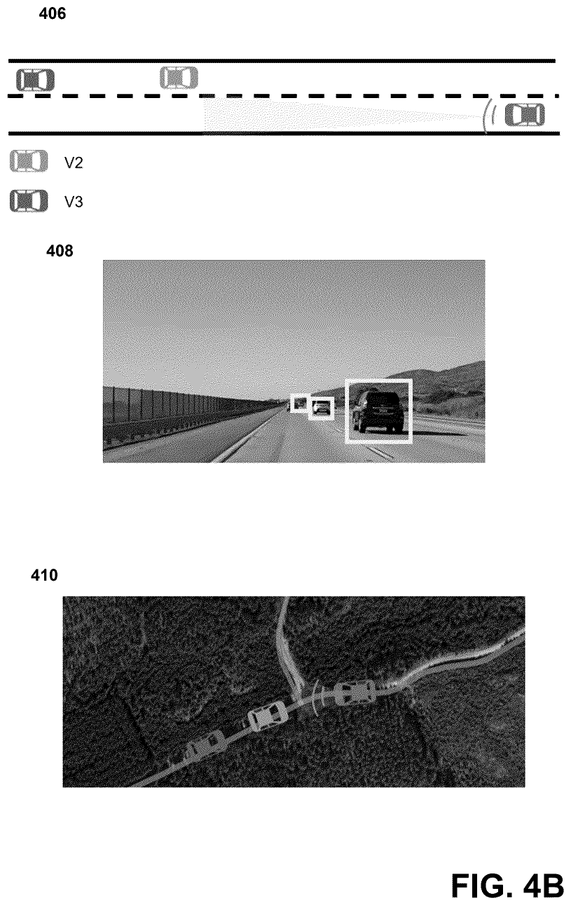

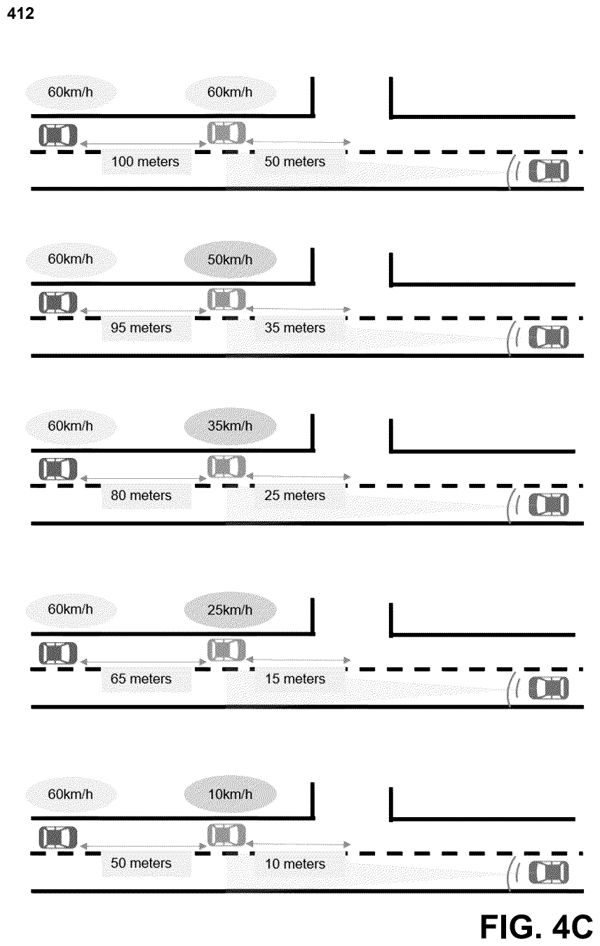

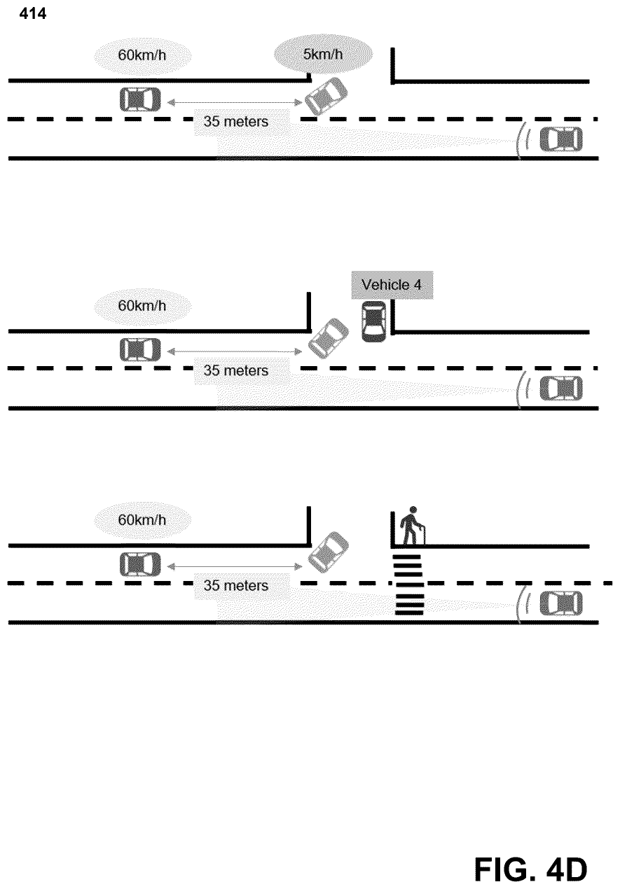

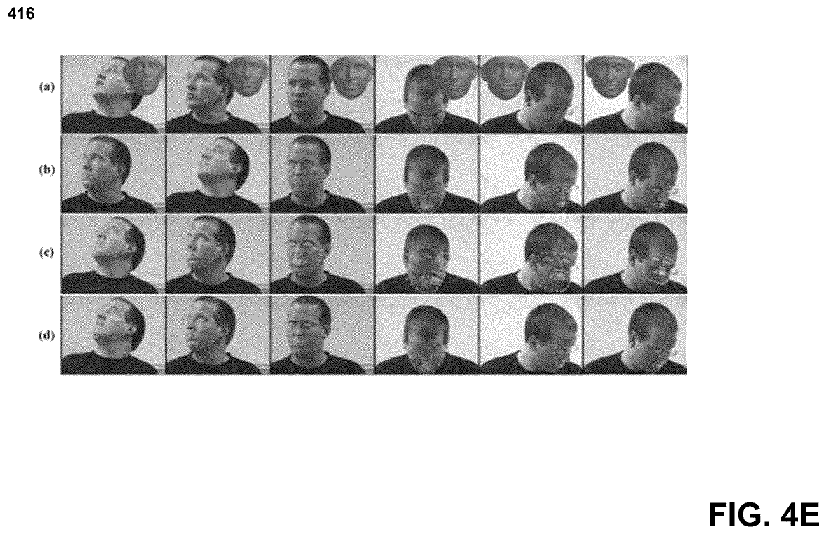

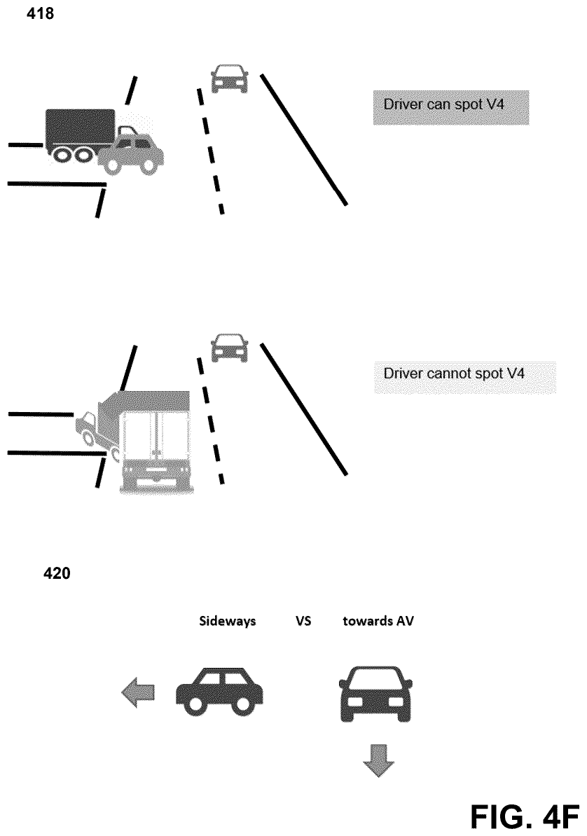

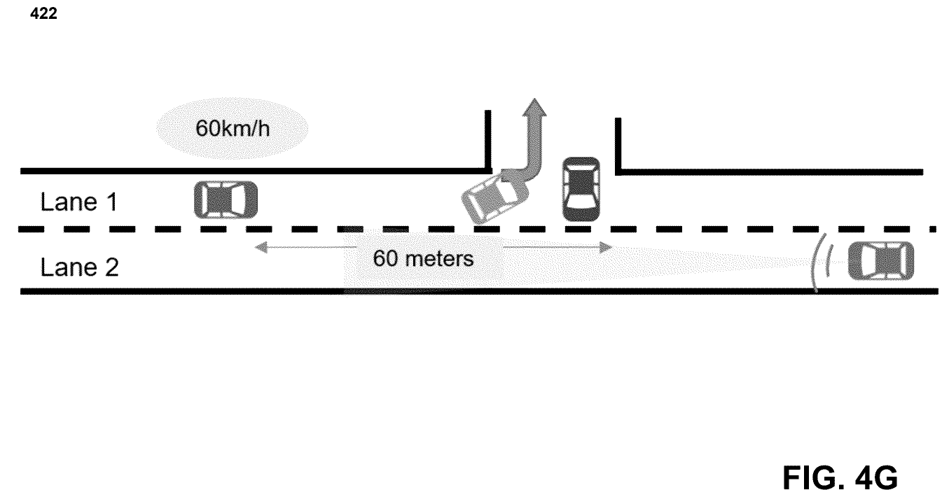

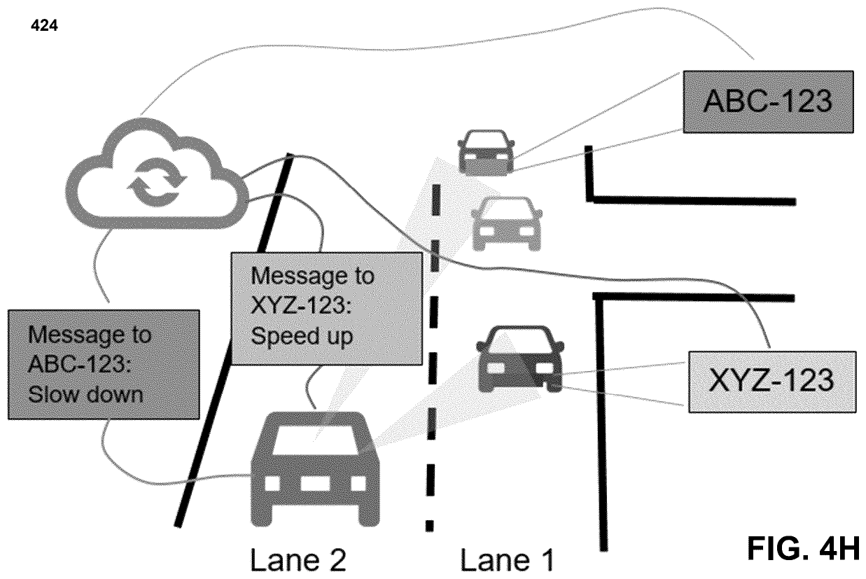

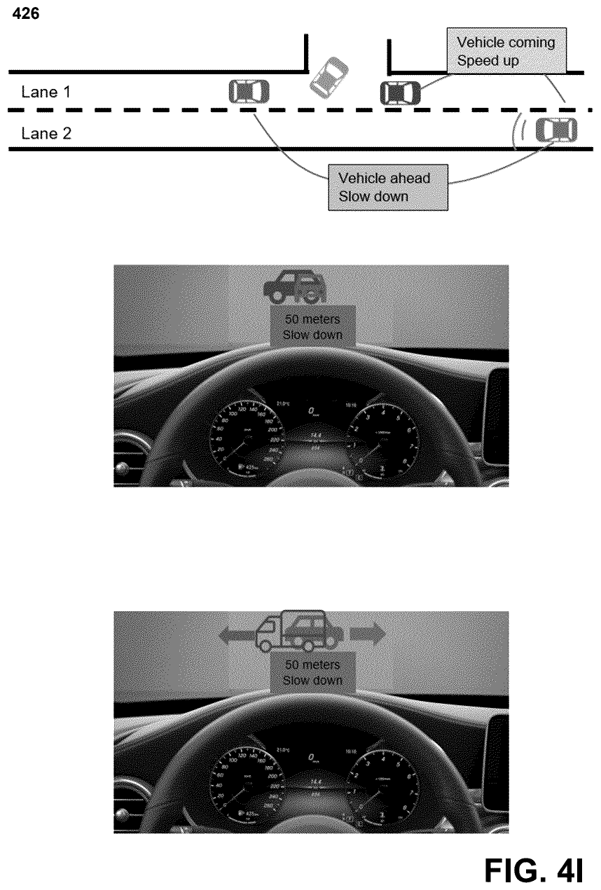

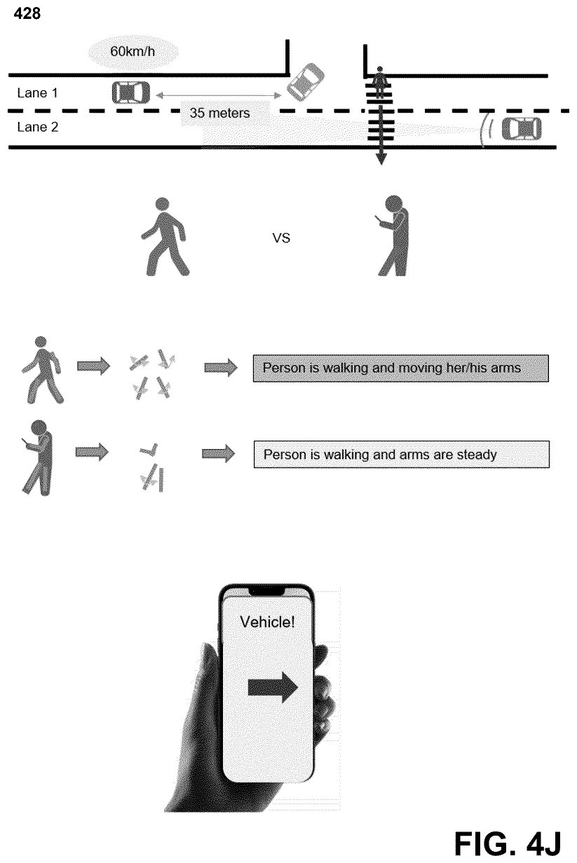

Next, FIGS. 4A-4J illustrate diagrams of example, non-limiting computer implemented methods that can facilitate blind spot detection and collision prevention, and which include example road scenarios for blind spot detection and collision prevention, in accordance with one or more embodiments described herein.

At 402, the AV can perform vehicle detection while driving. The AV can detect the presence of other vehicles or objects while driving. If the AV detects the presence of another vehicle, the AV can further identify 404 significant attributes of the detected vehicle that would be relevant to blind spot detection and/or collision prevention. For example, the AV could detect a size of the detected vehicle, and recognize that a larger vehicle can cause a greater obstruction of view (e.g., create a larger blind spot area for other nearby vehicles). The AV can also recognize that a detected vehicle is longer (for example, if the detected vehicle is a truck or has a hitch attached it). The AV can recognize that longer vehicles can cause a greater obstruction of view while performing a turn. The AV can further detect a location, speed, or vehicle type of the detected vehicle, or any other relevant information that could impact blind spot detection and/or collision prevention. The AV can use computer vision to detect the above described relevant information and to identify the above described significant attributes.

At 406, the AV can detect multiple vehicles within a single lane. The AV can determine that two or more vehicles are traveling behind one another in a single lane. The AV can determine that a first vehicle (V2) is traveling in front of a second vehicle (V3). The AV can determine that V2 is blocking V3's forward view (e.g., V2 has created a blind spot in front of V3). The AV can also detect the relative speeds of the detected vehicles.

At 408, the AV can detect whether a vehicle's (V2's) speed has changed. In response to detecting that the vehicle's speed has not changed, the AV can further determine that a risk of collision is reduced. For example, the AV could determine that a predicted risk of collision increases if the detected vehicle attempts to perform a nearby turn. The AV can predict that, because the detected vehicle has not changed its speed, the detected vehicle will not attempt to turn. Therefore, the AV can predict that the risk of collision is low.

At 410, the AV can detect whether a vehicle's (V2's) speed has changed. In response to detecting that the vehicle's speed has reduced, the AV can further attempt to detect why the detected vehicle's speed has reduced. For example, the AV can access traffic light information and/or GPS information using computer vision to detect why the vehicle's speed has decreased.

At 412, the AV can detect distance(s) between the detected vehicles, and distance(s) between the AV and the detected vehicles. For example, if V2's speed starts to slow while V3's speed remains constant, the distance between the two vehicles will likely decrease and the blind spot created by V2 will grow larger (as V2 will occupy more of V3's frontal view). In such a scenario, the AV can determine that the blind spot has increased in size. The AV can also attempt to determine why a change in speed has occurred. For example, the AV can analyze nearby traffic lights and/or signals. The AV can analyze road layouts by accessing geographical information systems such as GPS. The AV can further analyze behaviors of the detected vehicles, such as by performing light detection on the detected vehicles. The AV can infer intents of the detected vehicles. The inferred intent can be based at least in part on any one or more of road conditions, vehicle sizes, speeds, trajectories, and vehicle lights. If the detected vehicles are using GPS navigation, the AV can communicate with the detected vehicles and infer vehicle intent from the GPS navigation systems. For example, if V2 has an intended destination X, and the fastest route to X, according to V2's GPS, would be to take the next left turn, the AV can infer an intent of V2 to take the next left turn.

At 414, the AV can detect the presence of objects. The AV can determine an identity of a detected object. For example, the AV could determine that a detected object is another vehicle, a person, an animal, a construction zone, a road sign, a fallen tree, some form of debris, etc. The AV can detect multiple vehicles within a single lane. The AV can determine that two or more vehicles are traveling behind one another in a single lane. The AV can determine that a first vehicle (V2) is traveling in front of a second vehicle (V3). The AV can determine that V2 is blocking V3's forward view (e.g., V2 has created a blind spot in front of V3). The AV can determine that, as a result of the blind spot created by V2, V3 cannot see the detected object. For example, if the detected object is a pedestrian entering the road, the AV can determine that V3 cannot see the pedestrian because V3's view is being blocked by V2. If V2 is likely to make a turn, thereby exiting the lane, the AV can determine that a collision between V3 and the detected object (here, a pedestrian) is likely to occur. In order to prevent such a collision from occurring, or to reduce the severity of such a collision, the AV can issue a warning to nearby vehicles and/or pedestrians, or regulate operation of nearby vehicles.

At 416, the AV can analyze behavior of detected vehicles, including driver or passenger behavior of detected vehicles. The AV can also analyze behavior of detected pedestrians. The AV can use the detected behavior to infer an intent of the detected vehicles or pedestrians. In some embodiments, the AV can use visual analysis to detect the behavior of vehicles and/or pedestrians. For example, the AV can use head pose estimation algorithms. The AV can use the detected behavior in conjunction with other detected information, such as vehicle speed, light analysis, GPS analysis, etc., to perform a more robust and accurate analysis and make a more comprehensive determination of vehicle intent, blind spot detection, and/or collision probability.

At 418, the AV can determine respective sizes of detected vehicles. The AV can recognize that a larger vehicle can cause a greater obstruction of view (e.g., create a larger blind spot area for other nearby vehicles). The AV can also recognize that a detected vehicle is longer (for example, if the detected vehicle is a truck or has a hitch attached it). The AV can recognize that longer vehicles can cause a greater obstruction of view while performing a turn. The AV can further detect a location, speed, or vehicle type of the detected vehicle, or any other relevant information that could impact blind spot detection and/or collision prevention. For example, the AV can recognize that a larger vehicle in front of a smaller vehicle can cause a greater forward-facing blind spot for the smaller vehicle.

At 420, the AV can recognize that a smaller vehicle in front of a larger vehicle can cause a lesser forward-facing blind spot for the larger vehicle. The AV can determine driving conditions, including vehicle behavior and vehicle intent. For example, the AV can determine that a detected vehicle is incorporating into a lane. If the detected vehicle is longer, the AV can determine that the detected vehicle will cause a greater obstruction while performing the turn as compared to other, smaller vehicles making the same turn.

At 422, the AV can determine safe braking distances for detected vehicles. The AV can detect location, speed, or vehicle type of the detected vehicles, or any other relevant information that could impact the safe braking distances of the detected vehicles. For example, if a detected vehicle is moving at 90 mph, the AV can determine that it will require a greater braking distance than the same vehicle moving at 60mph would to avoid a collision. In another example, the AV could determine that a very large vehicle will require a greater breaking distance than a much smaller vehicle. The AV can use the determined safe braking distances for detected vehicles in conjunction with other identified information to perform a more robust and accurate analysis and make a more comprehensive determination of vehicle intent, blind spot detection, and/or collision probability.

At 424, the AV can label an identified situation on a safety scale. The AV can consider detected driving conditions, detected vehicles or pedestrians, detected vehicle types, speeds, distances between the vehicles, detected safe braking distances, and any other relevant factors in labeling the identified situation on a safety scale. In response to determining that the identified situation is at or above a certain threshold on the safety scale, the AV can employ any of the various safety measures detailed herein. The AV can communicate with detected vehicles or with detected pedestrians. According to an embodiment, the AV can communicate with detected vehicles using Vehicle-to-Vehicle (V2V) technology. According to another embodiment, the AV can detect a license plate number of a detected vehicle and can use a cloud communication system or server as an intermediary to communicate with the detected vehicle(s).

At 426, the AV can issue warnings and/or other information to the detected vehicles, to drivers of the detected vehicles, and to passengers of the detected vehicles. According to an embodiment, the AV can display information using audio or visual systems of the detected vehicles, such as heads-up displays, dashboards, GPS screens, etc. For example, the AV could determine that a detected vehicle (V3) needs to slow down in order to avoid a collision. The AV could cause a notification to be displayed on V3's heads-up display. The notification could comprise a warning, driving instructions, or any other information which could help V3 avoid future collision.

At 428, in the event a predicted future collision involves a detected pedestrian, the AV can communicate to the pedestrian via a device. For example, if the pedestrian is holding a phone, the AV could issue a warning or instructions to the pedestrian via the phone. The AV can detect relevant information pertaining to the pedestrian, such as if the pedestrian is looking away from an oncoming vehicle and therefore does not see that he or she is in danger of being hit. The AV can use this information to determine that a warning is necessary. There can be instances in which a detected pedestrian has a communication device on his or her person, but that device is not readily accessible. For example, a pedestrian could have a phone in her pocket, and therefore would not be able to immediately perceive a warning issued by the AV. Alternatively, the pedestrian could have the phone in her hand, but have her hand at her side. The AV can perform pose estimation algorithms to detect if the pedestrian can readily perceive a warning issued by the AV, or to determine if a certain type of warning would be more effective than others. For example, the Av can determine if the pedestrian is readily looking at her phone. In such as case, the AV could determine that displaying a warning on the screen of the pedestrian's phone is the best possible warning. However, if the AV determines that the pedestrian has a phone or other communication device in her pocket or purse, the AV can determine that causing the device to transmit an audio warning on its speakers would be a more effective intervention for avoiding a perceived future collision. Alternatively, the AV could determine that the pedestrian at risk does not have any communication device readily available, but that another nearby third-party who is not at risk does have a communication device readily available. In such a case, the AV can determine that issue the warning to the nearby third-party would be the most effective form of intervention to avoid the predicted future collision It should be noted that the communication devices noted above are not limited to mobile communication devices, nor to portable communication devices. For example, if the AV is traveling near an electronic billboard, the AV could determine that the most effective intervention might be to display a warning from the electronic billboard. In such a case, the AV could facilitate such a warning being displayed. The AV can determine under which conditions to notify a pedestrian. The AV can determine whether the conditions are satisfied before issuing the warning.

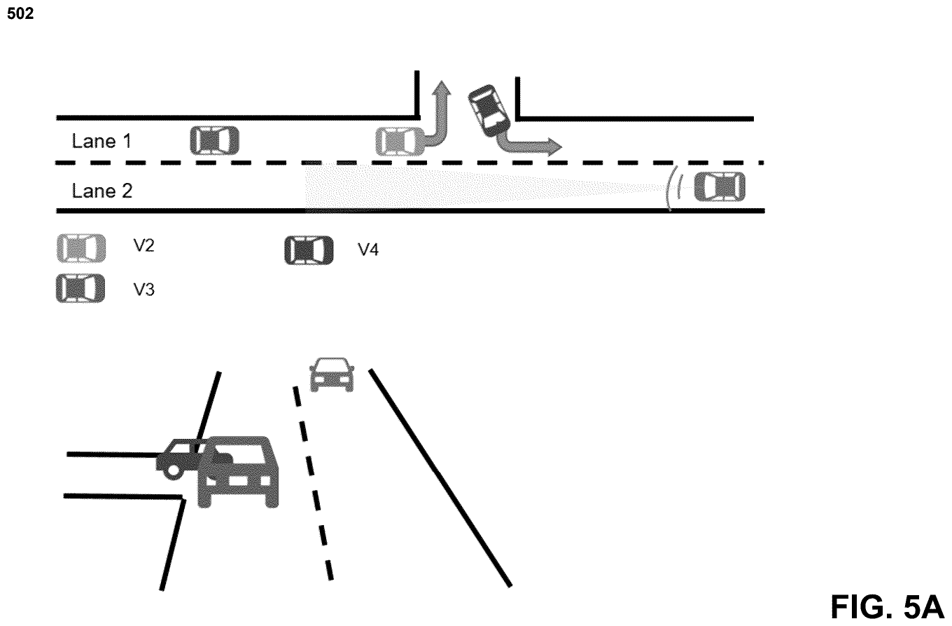

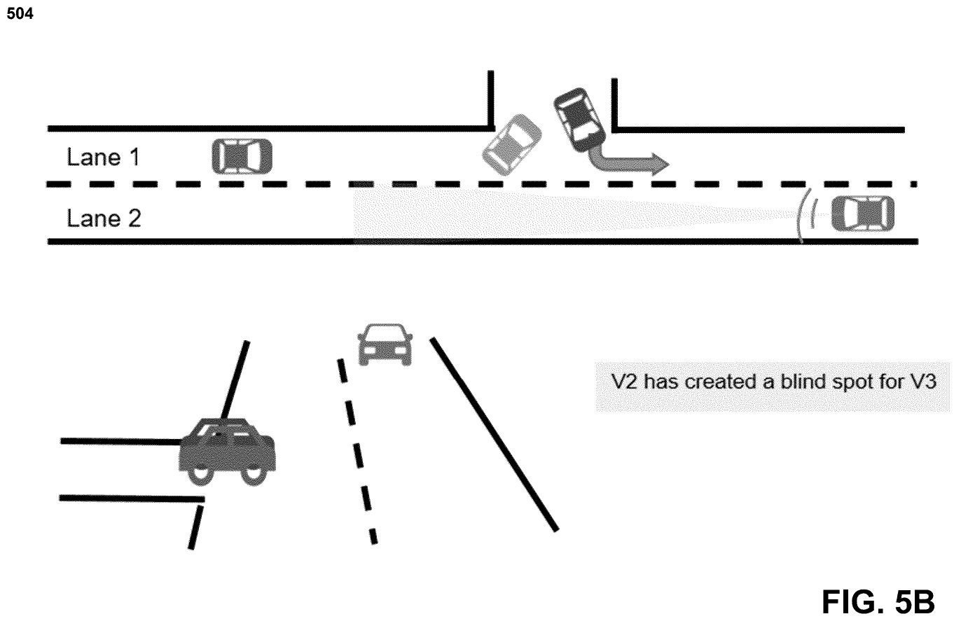

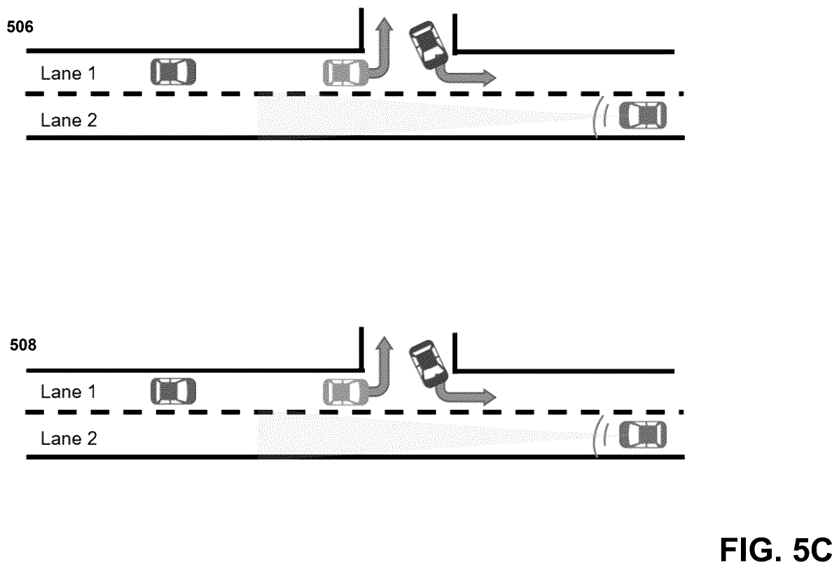

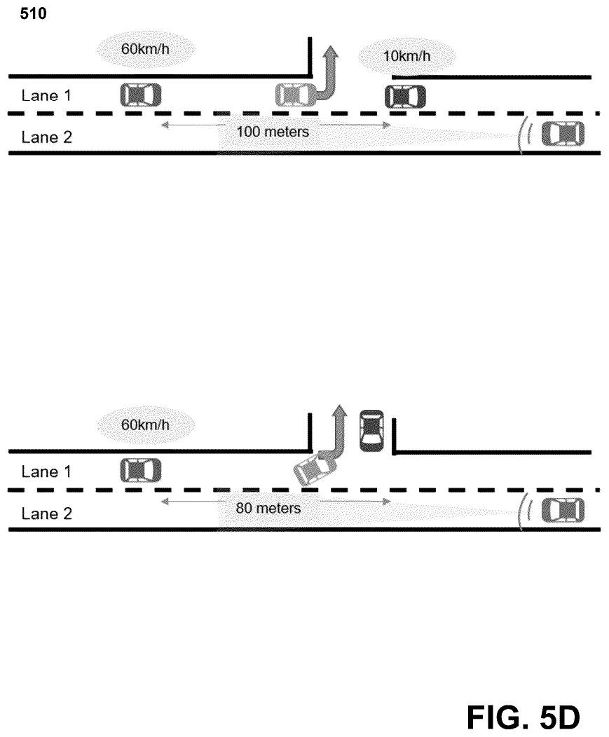

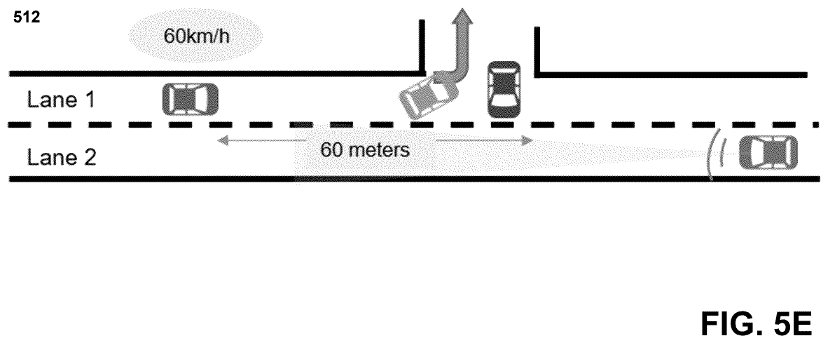

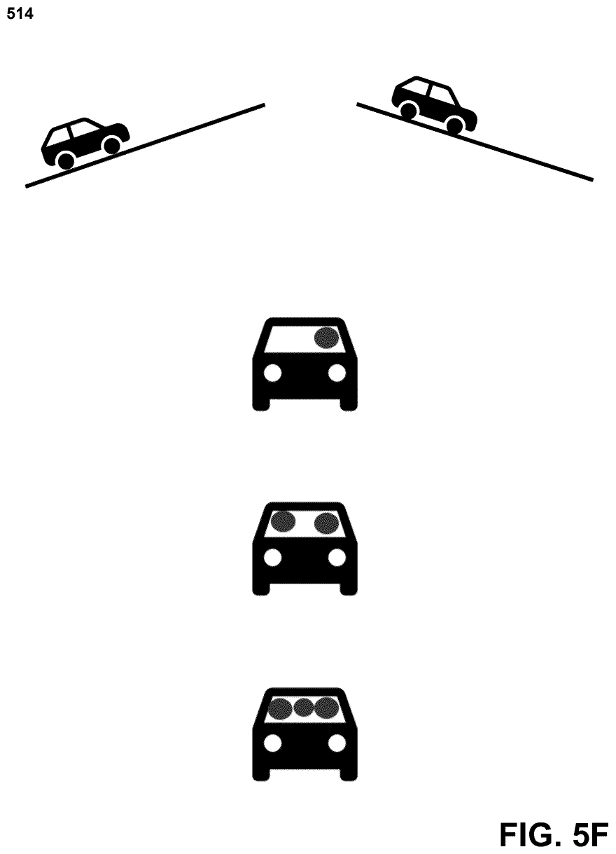

Next, FIGS. 5A-5F illustrates example road scenarios for blind spot detection and collision prevention in accordance with one or more embodiments described herein.

At 502, the AV can determine that a vehicle (V4) is waiting to enter the lane. The AV can further identify an oncoming vehicle (V2) within the lane. In the example, unbeknownst to V4, V2 is being followed by a third vehicle (V3). V2 can indicate to V4 that it intends to perform a turn and exit the lane (for example, but using the turning signal). Based on the above described scenario, the AV can determine that V2 has an intent to exit the lane. The AV can further determine that V4 is aware of V2's intent to exit. At 504, the AV can determine that V2 is between V4 and V3, such that V4 and V3 are unaware of one another. Based upon the above described information, and any other information which the AV analyzes (such as the sizes, speeds, locations and inferred intents of the other vehicles), the AV can make a prediction of a likelihood of collision. For example, if V4 determines that V2 is exiting the lane but is unaware that V2 is being followed by V3, V4 may assume that the lane will be empty once V2 exits. At 506, based on this assumption, V4 can begin to enter the lane. The AV can use this information to determine whether a collision between V3 and V4 is likely to occur. If V3 is moving faster, the AV can infer that the collision is more likely to occur. If the AV determines that the driver of V3 is not paying attention, the AV can determine that the collision is more likely to occur. Similarly, at 508, if the AV determines that the driver of V3 is paying attention, the AV can determine that the collision is not likely to occur.

At 510, the AV can determine respective distances between the vehicles, or between the AV and any one or more of the vehicles. The AV can use this information to anticipate a likelihood of collision. The AV can use the determined distances in conjunction with other detected information, such as vehicle speed, light analysis, GPS analysis, etc., to perform a more robust and accurate analysis and to make a more comprehensive determination of vehicle intent, blind spot detection, and/or collision probability. For example, where the distances between the respective vehicles are greater, the AV can determine that a predicted likelihood of collision is lower.

In contrast, at 512, where the respective distances between the vehicles are lesser, the AV can determine that a predicted likelihood of collision is greater. The AV can analyze changes in distances between respective vehicles to determine relative speeds, locations, and directions of the respective vehicles. The AV can consider any relevant factors, such as whether a vehicle has incorporated into a lane, the relative awareness of the drivers of the vehicles, and the relative shapes, sizes, models and makes of the detected vehicles.

At 514, the AV can determine a safe braking distance of an identified vehicle. When determining the safe braking distance, the AV can consider all relevant factors. For example, the AV can consider the type, model, make, size, age, and condition of the identified vehicle. The AV can also consider environmental factors and road conditions, such as the incline of a road, when calculating the safe braking distance. The AV can also consider the number of passengers or the amount or type of cargo within the identified vehicle when calculating the safe braking distance. For example, if the AV determines that the identified vehicle has five passengers and several heavy cargo items inside of it, the AV can determine that the safe braking distance of the identified vehicle will be greater than the same type of vehicle without any passengers or cargo present. Additionally, the AV can consider how the contents of the vehicle, such as the passengers or cargo, might impact the visibility of a driver of the vehicle. For example, if numerous passengers are present in the rear seats of the vehicle, the AV can determine that the rear view of a driver of the vehicle is more obstructed compared to the view of a driver of the same vehicle when no passengers or cargo are present.

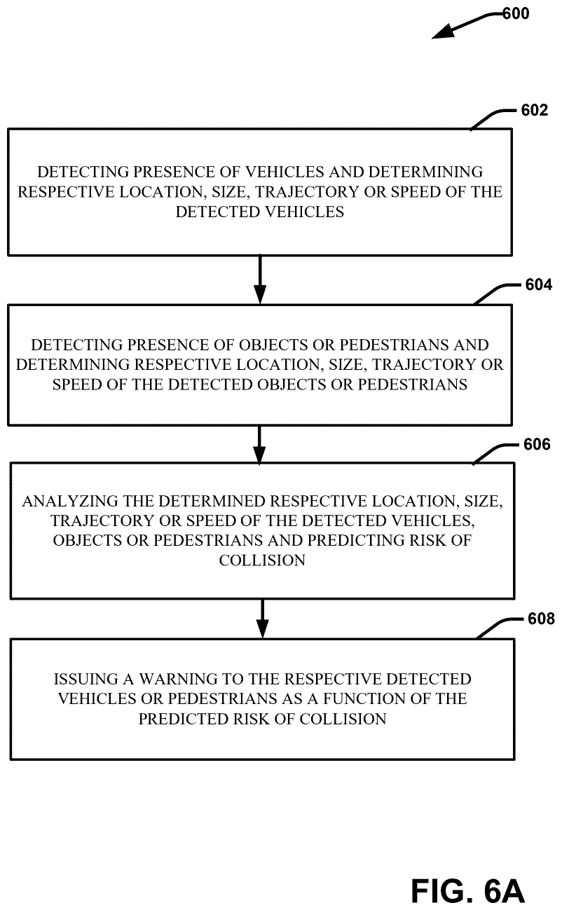

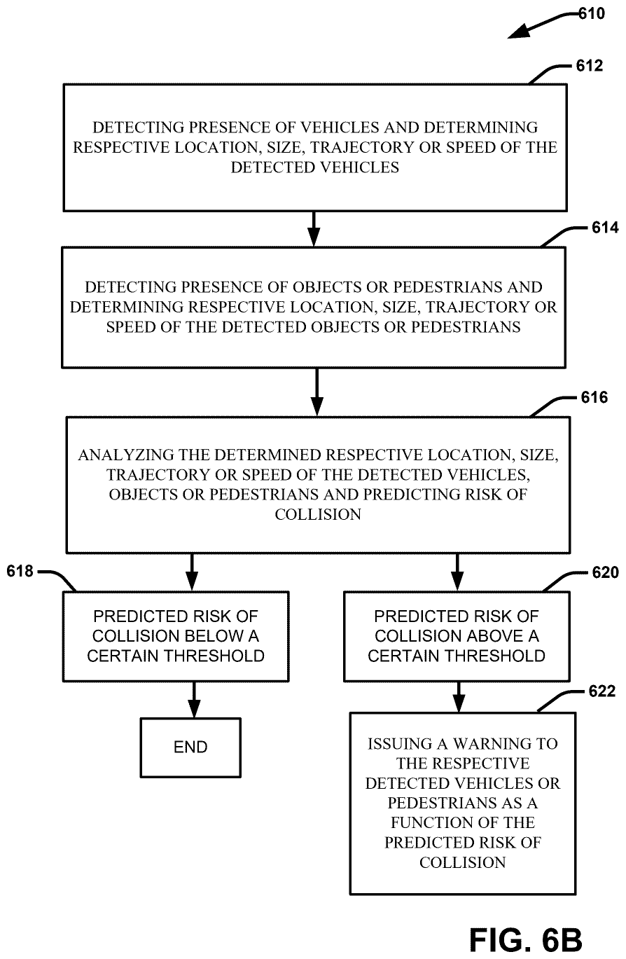

Next, FIGS. 6A and 6B illustrates flow diagrams of methods 600 and 610 that can facilitate early detection of vehicle blind spots and proactive collision prevention in accordance with some embodiments described herein, such as the system 200 of FIG. 2 and the system 100 of FIG. 1. While the methods 600 and 610 are described relative to the system 200 of FIG. 2, the methods 600 and 610 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 602, the method 600 includes detecting presence of vehicles and determining respective location, size, trajectory or speed of the detected vehicles. The method 600 can use a system operatively coupled to the processor (e.g., vehicle detection component 130) to detect the presence of vehicles and determine the respective location, size, trajectory or speed of the detected vehicles.

At 604, method 600 includes detecting presence of objects or pedestrians and determining respective location, size, trajectory or speed of the detected objects or pedestrians. The method 600 can use a system operatively coupled to the processor (e.g., environmental detection component 132) to detect the presence of objects or pedestrians and to determine the respective location, size, trajectory or speed of the detected objects or pedestrians.

At 606, method 600 includes analyzing the determined respective location, size, trajectory or speed of the detected vehicles, objects or pedestrians and predicting risk of collision. The method 600 can use a system operatively coupled to the processor (e.g., accident risk analysis component 134) to analyze the determined respective location, size, trajectory or speed of the detected vehicles, objects or pedestrians and predict the risk of collision.

At 608, method 600 includes issuing a warning to the respective detected vehicles or pedestrians as a function of the predicted risk of collision. The method 600 can use a system operatively coupled to the processor (e.g., communication component 136) to issue the warning to the respective detected vehicles or pedestrians.

In some embodiments, method 600 is performed by a system, such as system 100 of FIG. 1 or system 200 of FIG. 2.

In some embodiments, the method 600 can further comprise identifying blind spots of the detected vehicles. The method 600 can further comprise using the identified blind spots to predict the risk of collision. The method 600 can further comprise detecting behaviors of the vehicles. The method 600 can further comprise facilitating driving of the detected vehicles based on the predicted risk of collision. The method 600 can further comprise using radar and visual sensors to detect the presence of the vehicles. The method 600 can further comprise using radar and visual sensors to determine the respective location, size, trajectory or speed of the detected vehicles.

At 612, the method 610 includes detecting presence of vehicles and determining respective location, size, trajectory or speed of the detected vehicles. The method 610 can use a system operatively coupled to the processor (e.g., vehicle detection component 130) to detect the presence of vehicles and determine the respective location, size, trajectory or speed of the detected vehicles.

At 614, method 610 includes detecting presence of objects or pedestrians and determining respective location, size, trajectory or speed of the detected objects or pedestrians. The method 610 can use a system operatively coupled to the processor (e.g., environmental detection component 132) to detect the presence of objects or pedestrians and to determine the respective location, size, trajectory or speed of the detected objects or pedestrians.

At 616, method 610 includes analyzing the determined respective location, size, trajectory or speed of the detected vehicles, objects or pedestrians and predicting risk of collision. The method 610 can use a system operatively coupled to the processor (e.g., accident risk analysis component 134) to analyze the determined respective location, size, trajectory or speed of the detected vehicles, objects or pedestrians and predict the risk of collision. The predicted risk of collision can be above or below a certain threshold. The threshold can be a predefined threshold.

At 618, the method 610 includes determining that the predicted risk of collision is below a certain threshold. The method 610 can use a system operatively coupled to the processor (e.g., accident risk analysis component 134) to determine the predicted risk of collision is below the threshold. In response to the determining that the predicted risk of collision is below the threshold, the method 610 ends.

At 620, the method 610 includes determining that the predicted risk of collision is above a certain threshold. The method 610 can use a system operatively coupled to the processor (e.g., accident risk analysis component 134) to determine the predicted risk of collision is above the threshold. In response to the determining that the predicted risk of collision is above the threshold, the method 610 continues to 622.

At 622, method 610 includes issuing a warning to the respective detected vehicles or pedestrians as a function of the predicted risk of collision. The method 610 can use a system operatively coupled to the processor (e.g., communication component 136) to issue the warning to the respective detected vehicles or pedestrians.

In some embodiments, method 610 is performed by a system, such as system 100 of FIG. 1 or system 200 of FIG. 2.

In some embodiments, the method 610 can further comprise identifying blind spots of the detected vehicles. The method 610 can further comprise using the identified blind spots to predict the risk of collision. The method 610 can further comprise detecting behaviors of the vehicles. The method 610 can further comprise facilitating driving of the detected vehicles based on the predicted risk of collision. The method 610 can further comprise using radar and visual sensors to detect the presence of the vehicles. The method 610 can further comprise using radar and visual sensors to determine the respective location, size, trajectory or speed of the detected vehicles.

In order to provide additional context for various embodiments described herein, FIG. 7 and the following discussion are intended to provide a brief, general description of a suitable computing environment 700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors, field-programmable gate array, AI accelerator application-specific integrated circuit, or other suitable processors. Dual microprocessors and other multi-processor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 712 can also include a high-speed RAM such as static RAM for caching data. It is noted that unified Extensible Firmware Interface(s) can be utilized herein.

The computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and an optical disk drive 720 (e.g., which can read or write from a disc 722 such as a CD-ROM disc, a DVD, a BD, etc.). While the internal HDD 714 is illustrated as located within the computer 702, the internal HDD 714 can also be configured for external use in a suitable chassis (not shown). Additionally, while not shown in environment 700, a solid-state drive (SSD) could be used in addition to, or in place of, an HDD 714. The HDD 714, external storage device(s) 716 and optical disk drive 720 can be connected to the system bus 708 by an HDD interface 724, an external storage interface 726 and an optical drive interface 728, respectively. The interface 724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, and/or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the . NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

Further, computer 702 can be enabled with a security module, such as a trusted processing module (TPM). For instance, with a TPM, boot components hash next in time boot components, and wait for a match of results to secured values, before loading a next boot component. This process can take place at any layer in the code execution stack of computer 702, e.g., applied at the application execution level or at the operating system (OS) kernel level, thereby enabling security at any level of code execution.

A user can enter commands and information into the computer 702 through one or more wired/wireless input devices, e.g., a keyboard 738, a touch screen 740, and a pointing device, such as a mouse 742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1394 serial port, a game port, a USB port, an IR interface, a BLUETOOTH® interface, etc.

A monitor 746 or other type of display device can also be connected to the system bus 708 via an interface, such as a video adapter 748. In addition to the monitor 746, a computer typically includes other peripheral output devices (not shown), such as speakers, printers, etc.

The computer 702 can operate in a networked environment using logical connections via wired and/or wireless communications to one or more remote computers, such as a remote computer(s) 750. The remote computer(s) 750 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 752 is illustrated. The logical connections depicted include wired/wireless connectivity to a local area network (LAN) 754 and/or larger networks, e.g., a wide area network (WAN) 756. Such LAN and WAN networking environments are commonplace in offices and companies, and facilitate enterprise-wide computer networks, such as intranets, all of which can connect to a global communications network, e.g., the Internet.

When used in a LAN networking environment, the computer 702 can be connected to the local network 754 through a wired and/or wireless communication network interface or adapter 758. The adapter 758 can facilitate wired or wireless communication to the LAN 754, which can also include a wireless access point (AP) disposed thereon for communicating with the adapter 758 in a wireless mode.

When used in a WAN networking environment, the computer 702 can include a modem 760 or can be connected to a communications server on the WAN 756 via other means for establishing communications over the WAN 756, such as by way of the Internet. The modem 760, which can be internal or external and a wired or wireless device, can be connected to the system bus 708 via the input device interface 744. In a networked environment, program modules depicted relative to the computer 702 or portions thereof, can be stored in the remote memory/storage device 752. It will be appreciated that the network connections shown are example and other means of establishing a communications link between the computers can be used.

When used in either a LAN or WAN networking environment, the computer 702 can access cloud storage systems or other network-based storage systems in addition to, or in place of, external storage devices 716 as described above. Generally, a connection between the computer 702 and a cloud storage system can be established over a LAN 754 or WAN 756 e.g., by the adapter 758 or modem 760, respectively. Upon connecting the computer 702 to an associated cloud storage system, the external storage interface 726 can, with the aid of the adapter 758 and/or modem 760, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

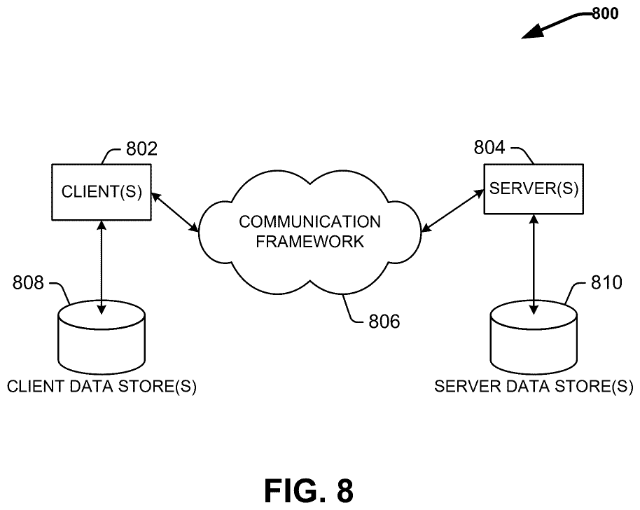

Referring now to FIG. 8, there is illustrated a schematic block diagram of a computing environment 800 in accordance with this specification. The system 800 includes one or more client(s) 802, (e.g., computers, smart phones, tablets, cameras, PDA's). The client(s) 802 can be hardware and/or software (e.g., threads, processes, computing devices). The client(s) 802 can house cookie(s) and/or associated contextual information by employing the specification, for example.

The system 800 also includes one or more server(s) 804. The server(s) 804 can also be hardware or hardware in combination with software (e.g., threads, processes, computing devices). The servers 804 can house threads to perform transformations of media items by employing aspects of this disclosure, for example. One possible communication between a client 802 and a server 804 can be in the form of a data packet adapted to be transmitted between two or more computer processes wherein data packets may include coded analyzed headspaces and/or input. The data packet can include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804. Further, the client(s) 802 can be operatively connected to one or more server data store(s) 810.

In one exemplary implementation, a client 802 can transfer an encoded file, (e.g., encoded media item), to server 804. Server 804 can store the file, decode the file, or transmit the file to another client 802. It is noted that a client 802 can also transfer uncompressed file to a server 804 and server 804 can compress the file and/or transform the file in accordance with this disclosure. Likewise, server 804 can encode information and transmit the information via communication framework 806 to one or more clients 802.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:
1. A system, comprising: one or more sensors integrated on or within a vehicle; a memory that stores computer executable components; and a processor that executes the computer executable components stored in the memory, wherein the computer executable components comprise: a vehicle detection component detects presence of vehicles and determines respective location, size, trajectory or speed of the detected vehicles; an environmental detection component that detects respective objects or pedestrians and determines location, size, trajectory or speed of the respective detected objects or pedestrians; an accident risk analysis component that analyzes the determined respective location, size, trajectory or speed of the respective detected vehicles, objects or pedestrians and predicts risk of collision; and a communication component that issues a warning to the respective detected vehicles or pedestrians as a function of the predicted risk of collision.
2. The system of any one or more preceding clause(s), further comprising a blind-spot detection component that uses information gathered by the vehicle detection component to identify blind spots of the detected vehicles.
3. The system of any one or more preceding clause(s), wherein the accident risk analysis component uses the identified blind spots to predict the risk of collision.
4. The system of any one or more preceding clause(s), wherein the accident risk analysis component predicts a high risk of collision based on the identified blind spots.
5. The system of any one or more preceding clause(s), wherein the environmental detection component further detects weather conditions.
6. The system of any one or more preceding clause(s), wherein the environmental detection component further detects road conditions.
7. The system of any one or more preceding clause(s), wherein the environmental detection component further detects behaviors of the pedestrians.
8. The system of any one or more preceding clause(s), wherein the vehicle detection component further detects behaviors of the vehicles.
9. The system of any one or more preceding clause(s), further comprising a regulation component that regulates driving of the vehicle based on the predicted risk of collision.
10. The system of any one or more preceding clause(s), wherein the regulation component regulates driving of the detected vehicles based on the predicted risk of collision.
11. The system of any one or more preceding clause(s), wherein the vehicle detection component uses radar and visual sensors to detect the presence of the vehicles.
12. The system of any one or more preceding clause(s), wherein the vehicle detection component uses radar and visual sensors to determine the locations, sizes, trajectories or speeds of the detected vehicles.
13. A computer-implemented method that utilizes a processor that executes computer executable components stored in memory to perform the following acts: detecting presence of vehicles and determining respective location, size, trajectory or speed of the detected vehicles; detecting presence of objects or pedestrians and determining respective location, size, trajectory or speed of the detected objects or pedestrians; analyzing the determined respective location, size, trajectory or speed of the detected vehicles, objects or pedestrians and predicting risk of collision; and issuing a warning to the respective detected vehicles or pedestrians as a function of the predicted risk of collision.
14. The computer-implemented method of any one or more preceding clause(s), further comprising identifying blind spots of the detected vehicles.
15. The computer-implemented method of any one or more preceding clause(s), further comprising using the identified blind spots to predict the risk of collision.
16. The computer-implemented method of any one or more preceding clause(s), further comprising detecting behaviors of the vehicles.
17. The computer-implemented method of any one or more preceding clause(s), further comprising facilitating driving of the detected vehicles based on the predicted risk of collision.
18. The computer-implemented method of any one or more preceding clause(s), further comprising using radar and visual sensors to detect the presence of the vehicles.
19. The computer-implemented method of any one or more preceding clause(s), further comprising using radar and visual sensors to determine the respective location, size, trajectory or speed of the detected vehicles.
20. A computer program product comprising a computer readable storage medium having program instructions embodied therewith, the program instructions executable by a processor to cause the processor to: detect presence of vehicles and determine respective location, size, trajectory or speed of the detected vehicles; detect presence of objects or pedestrians and determine respective location, size, trajectory or speed of the detected objects or pedestrians; analyze the determined respective location, size, trajectory or speed of the detected vehicles, objects or pedestrians and predict risk of collision; and issue a warning to the respective detected vehicles or pedestrians as a function of the predicted risk of collision.
21. Any suitable combination of any one or more of system clauses 1-12.
22. Any suitable combination of any one or more method clauses 13-19.
23. Any suitable combination non-transitory machine-readable storage medium clause 20.
24. Any suitable combination of any features of any one or more of clauses 1-20.

What is claimed is:

1. A system onboard a vehicle, comprising:
a memory that stores computer executable components; and
a processor that executes the computer executable components stored in memory, wherein the computer executable components comprise:
a vehicle detection component that detects presence of vehicles and determines respective location, size, trajectory or speed of the detected vehicles;
an environmental detection component that detects respective objects or pedestrians and determines location, size, trajectory or speed of the respective detected objects or pedestrians;
an accident risk analysis component that analyzes the determined respective location, size, trajectory or speed of the respective detected vehicles, objects or pedestrians and predicts risk of collision; and
a communication component that issues a warning to the respective detected vehicles or pedestrians as a function of the predicted risk of collision.

2. The system of claim 1, further comprising a blind-spot detection component that uses information gathered by the vehicle detection component to identify blind spots of the detected vehicles.

3. The system of claim 2, wherein the accident risk analysis component uses the identified blind spots to predict the risk of collision.

4. The system of claim 3, wherein the accident risk analysis component predicts a high risk of collision based on the identified blind spots.

5. The system of claim 1, wherein the environmental detection component further detects weather conditions.

6. The system of claim 1, wherein the environmental detection component further detects road conditions.

7. The system of claim 1, wherein the environmental detection component further detects behaviors of the pedestrians.

8. The system of claim 1, wherein the vehicle detection component further detects behaviors of the vehicles.

9. The system of claim 1, further comprising a regulation component that regulates driving of the vehicle based on the predicted risk of collision.

10. The system of claim 9, wherein the regulation component regulates driving of the detected vehicles based on the predicted risk of collision.

11. The system of claim 1, wherein the vehicle detection component uses radar and visual sensors to detect the presence of the vehicles.

12. The system of claim 1, wherein the vehicle detection component uses radar and visual sensors to determine the locations, sizes, trajectories or speeds of the detected vehicles.

13. A computer-implemented method performed by a data processing device of a vehicle, comprising:
detecting presence of vehicles and determining respective location, size, trajectory or speed of the detected vehicles;
detecting presence of objects or pedestrians and determining respective location, size, trajectory or speed of the detected objects or pedestrians;
analyzing the determined respective location, size, trajectory or speed of the detected vehicles, objects or pedestrians and predicting risk of collision; and
issuing a warning to the respective detected vehicles or pedestrians as a function of the predicted risk of collision.

14. The computer-implemented method of claim 13, further comprising identifying blind spots of the detected vehicles.

15. The computer-implemented method of claim 14, further comprising using the identified blind spots to predict the risk of collision.

16. The computer-implemented method of claim 13, further comprising detecting behaviors of the vehicles.

17. The computer-implemented method of claim 13, further comprising facilitating driving of the detected vehicles based on the predicted risk of collision.

18. The computer-implemented method of claim 13, further comprising using radar and visual sensors to detect the presence of the vehicles.

19. The computer-implemented method of claim 13, further comprising using radar and visual sensors to determine the respective location, size, trajectory or speed of the detected vehicles.

20. A non-transitory machine-readable storage medium, comprising executable instructions that, when executed by a processor onboard a vehicle, facilitate performance of operations, comprising:
detecting presence of vehicles and determining respective location, size, trajectory or speed of the detected vehicles;
detecting presence of objects or pedestrians and determining respective location, size, trajectory or speed of the detected objects or pedestrians;
analyzing the determined respective location, size, trajectory or speed of the detected vehicles, objects or pedestrians and predicting risk of collision; and
issuing a warning to the respective detected vehicles or pedestrians as a function of the predicted risk of collision.
